(19) United States
(12) Patent Application Publication
(10) Pub. No.: US 2015/0137024 A1
(43) Pub. Date: May 21, 2015

(54) METAL-CARBON NANOTUBE COMPOSITE AND PREPARING METHOD OF THE SAME

(71) Applicants: RESEARCH & BUSINESS FOUNDATION SUNGKYUNKWAN UNIVERSITY, Suwon-si (KR); JC CORP., Siheung-si (KR)

(72) Inventors: Donghyun LEE, Yongin-si (KR); Seungyong SON, Suwon-si (KR); Doo Kyoo KIM, Seoul (KR); Ki Chull SHIN, Siheung-si (KR)

(73) Assignees: RESEARCH & BUSINESS FOUNDATION SUNGKYUNKWAN UNIVERSITY, Suwon-si (KR); JC CORP., Siheung-si (KR)

(21) Appl. No.: 14/549,868

(22) Filed: Nov. 21, 2014

(30) Foreign Application Priority Data
Nov. 21, 2013 (KR) 10-2013-0142037

(51) Int. Cl. H01F 1/42

(52) U.S. Cl. CPC H01F 1/42
USPC 252/62.55

(57) ABSTRACT

A metal-carbon nanotube composite is provided which includes a carbon nanotube, a magnetic material, and a metal and in which the carbon nanotube is bound to the magnetic material through a binding intervenor and the carbon nanotube is dispersed in the metal by binding the magnetic material to the metal. A preparing method of a metal-carbon nanotube composite is provided, the method including: a step of binding a carbon nanotube to a magnetic material through a binding intervenor; and a step of dispersing the carbon nanotube in a metal by binding the magnetic material to the metal.

### CROSS-REFERENCE TO RELATED APPLICATION

This application claims the benefit under 35 USC 119(a) of Korean Patent Application No. 10-2013-0142037 filed on Nov. 21, 2013, in the Korean Intellectual Property Office, the entire disclosure of which is incorporated herein by reference for all purposes.

### BACKGROUND

1. Field

The present disclosure relates to a preparing method of a metal-carbon nanotube composite and a metal-carbon nanotube composite prepared by the preparing method.

2. Description of Related Art

Fullerenes, carbon nanotubes, graphene, graphite, and the like are low-dimensional nano-materials composed of carbon atoms. That is, carbon atoms configured in a hexagonal arrangement may form a zero-dimensional fullerene formed in a ball, may form carbon nanotubes one-dimensionally rolled, may form graphene of a two-dimensional monolayer, and may form graphite three-dimensionally stacked.

A carbon nanotube has a cylindrical structure on the scale of nanometers and may include carbon atoms arranged in a spiral form. With such a structure, carbon nanotubes may have certain unique physical properties that cannot be observed in a general material. With regard to such carbon nanotubes, various application technologies have been developed for using the excellent physical properties of such the carbon nanotubes, e.g., unique electrical property, intensity, a restoration property, and thermal conductivity.

However, generally, for single-walled carbon nanotubes, all the atoms constituting the carbon nanotubes are surface atoms. Accordingly, the carbon nanotubes readily aggregate by a van der Waals force. Most single-walled carbon nanotubes therefore form into a structure of a bundle or an aggregate including multiple carbon nanotubes. Generally, multi-walled carbon nanotubes also form a large aggregate and are entangled with one another in a net-like structure.

A variety of conventional methods have been employed for dispersing a carbon nanotube in a solution. For example, a physical dispersion treatment method such as an ultrasonic wave treatment has been employed. Such a physical dispersion treatment method includes putting a single-walled carbon nanotube aggregate in acetone to disperse the carbon nanotubes therein through an ultrasonic wave treatment. Also, putting a material such as a surfactant or the like into a solvent to increase the hydrophilic property of the carbon nanotubes in conjunction with ultrasonic wave treatment has been employed. By way of example, Korean Patent Application Publication No. 2010-0051927 discloses a combined pulverization and dispersion system to disperse carbon nanotubes. However, such a conventional method for dispersing a carbon nanotube may have insignificant dispersion effects in certain circumstances, and such method cannot be applied to a dispersion of carbon nanotubes in a solvent such as a metal. In particular, it has been difficult to disperse a carbon nanotube material in a metal due to coherence, a hydrophobic property and a very low volume density of the carbon nanotubes, as well as a difference in specific gravity between the carbon nanotubes and the metal.

A conventional metal-carbon nanotube dispersion method includes chemically introducing a hydroxyl group to a surface of a carbon nanotube and inducing a covalent bond between the carbon nanotube and a metal through plasma melting. Also, there is a method of introducing a functional group containing oxygen to a surface of a carbon nanotube using ultrasonic waves. However, such methods cause defects in the carbon nanotubes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In view of the foregoing, the present disclosure provides a metal-carbon nanotube composite which includes a carbon nanotube, a magnetic material, and a metal and in which the carbon nanotube is bound to the magnetic material through a binding intervenor and the carbon nanotube is dispersed in the metal by binding the magnetic material to the metal, and a preparing method of a metal-carbon nanotube composite, the method including: a step of binding a carbon nanotube to a magnetic material through a binding intervenor; and a step of dispersing the carbon nanotube in a metal by binding the magnetic material to the metal.

However, problems to be solved by the present disclosure are not limited to the above-described problems. Although not described herein, other problems to be solved by the present disclosure can be clearly understood by those skilled in the art from the following descriptions.

In one general aspect, a preparing method of a metal-carbon nanotube composite includes a step of binding a carbon nanotube to a magnetic material through a binding intervenor; and a step of dispersing the carbon nanotube in a metal by binding the magnetic material to the metal, in which the binding intervenor includes a radical initiator or a compound represented by the following Chemical Formula 1: [Chemical Formula 1] A-B, in which A is an organic functional group which is bound to the carbon nanotube, and B is an organic functional group which is bound to the magnetic material.

The preparing method may provide that the metal includes a metal selected from the group consisting of Ni, Co, Fe, Pt, Au, Al, Cr, Cu, Mg, Mn, Mo, Rh, Si, Ta, Ti, W, U, V, Zr, and Ge, or an alloy thereof.

The preparing method may provide that the metal is in a molten state.

The preparing method may provide that the radical initiator includes a peroxide-based polymerization initiator, an azo-based polymerization initiator, a redox-based polymerization initiator, or combinations thereof.

The preparing method may provide that the peroxide-based polymerization initiator includes ammonium persulfate, potassium persulfate, sodium persulfate, 1,1-bis(tert-aryl peroxy)cyclohexane, 1,1-di(t-amyl peroxy)cyclohexane, 1,1-bis(t-amyl peroxy)cyclohexane, 1,1-bis(t-butylperoxy)-3,3,5-trimethylcyclohexane, 1,1-bis(t-butylperoxy)cyclohexane, 2,2-bis(t-butylperoxy)butane, 2,4-pentanedione oxide, 2,5-bis(t-butylperoxide)-2,5-dimethylhexane, 2,5-di(t-butylperoxide)-2,5-dimethyl-3-hexyne, 2-butanone peroxide, benzoyl peroxide, cumene hydroperoxide, di-t-amyl peroxide, dicumyl peroxide, lauroyl peroxide, luperox, t-butyl hydroperoxide, t-butyl peracetate, t-butyl peroxybenzoate, t-butyl peroxide, t-butylperoxy-2-ethylhexyl carbonate, or combinations thereof.

The preparing method may provide that the azo-based polymerization initiator includes 1,1′-azobis(cyclohexane-1-carbonitrile), 2,2′-azobis(amidinopropane)dihydrochloride, 2,2′-azobis(2-methylbutyronitrile), 2,2′-azobisisobutyronitrile, 2,2′-azobis(2,4-dimethylvaleronitrile), 2,2′-azobis(4-methoxy-2,4-dimethylvaleronitrile), 4,4′-azobis(4-cyanovaleric acid), dimethyl-2,2′-azobisisobutyrate, 2,2′-azobis[2-(2-imidazolin-2-yl)propane]dihydrochloride, 2,2′-azobis[2-(2-imidazolin-2-yl)propane], 2,2′-azobis[2-(hydroxymethyl)propionitrile], or combinations thereof.

The preparing method may provide that the organic functional group which is combined with the carbon nanotube includes an aromatic organic functional group.

The preparing method may provide that the organic functional group which is combined with the magnetic material includes a carboxyl group, an aldehyde group, a hydroxy group, an epoxy group, or combinations thereof.

The preparing method may provide that the compound of the chemical formula 1 includes an aromatic carboxylic acid.

The preparing method may provide that the aromatic carboxylic acid includes benzoic acid, phthalic acid, or salicylic acid.

The preparing method may provide that the magnetic material includes a transition metal oxide.

The preparing method may provide that the transition metal oxide includes iron oxide, cobalt oxide, nickel oxide, chromium oxide, magnetite, or combinations thereof.

The preparing method may provide that the size of the magnetic material is from 1 nm to 50 nm.

The preparing method may provide that the step of binding the carbon nanotube to the magnetic material through the binding intervenor includes binding the magnetic material in a ratio of from 0.1 to 20 parts by weight of the magnetic material to 1 part by weight of the carbon nanotube.

The preparing method may provide that the step of dispersing the carbon nanotube in the metal includes dispersing the carbon nanotube in a ratio of 1 part by weight of carbon nanotube to from 1 to 500,000 parts by weight of the metal.

The preparing method may provide that the step of binding the carbon nanotube to the magnetic material through the binding intervenor includes preparing a mixture including the carbon nanotube, the magnetic material, and the binding intervenor, and stirring the mixture to bind the carbon nanotube and the magnetic material.

In another general aspect, a metal-carbon nanotube composite includes a carbon nanotube; a magnetic material; and a metal, in which the composite is prepared according to the preparing method, and in which the carbon nanotube and the magnetic material are homogeneously dispersed in the metal.

The metal-carbon nanotube composite may include the magnetic material in a ratio of from 0.1 to 20 parts by weight of the magnetic material to 1 part by weight of the carbon nanotube.

The metal-carbon nanotube composite may include the metal in a ratio of from 1 part by weight to 500,000 parts by weight of the metal to 1 part by weight of the carbon nanotube.

The foregoing summary is illustrative only and is not intended to be in any way limiting. In addition to the illustrative aspects, embodiments, and features described herein, further aspects, embodiments, and features will become apparent by reference to the drawings and the following detailed description.

### BRIEF DESCRIPTION OF THE DRAWINGS

FIG. 1 is a schematic diagram illustrating a preparing process of a metal-carbon nanotube composite in accordance with an example embodiment of the present disclosure.

FIG. 2A and FIG. 2B are scanning electron microscopic (SEM) images of metal-carbon nanotube composites in accordance with an example of the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise.

The term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

Through the whole document, the term “on” that is used to designate a position of one element with respect to another element includes both a case that the one element is adjacent to the another element and a case that any other element exists between these two elements.

Through the whole document, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, the term “binding intervenor” refers to a material that induces a chemical bond between a carbon nanotube and a magnetic material without damaging the carbon nanotube, and may include a material that can efficiently disperse the carbon nanotube in a metal as the carbon nanotube is chemically bound to the magnetic material.

Hereinafter, example embodiments and examples of the present disclosure will be explained in detail with reference to the accompanying drawings.

In one general aspect, a preparing method of a metal-carbon nanotube composite includes a step of binding a carbon nanotube to a magnetic material through a binding intervenor; and a step of dispersing the carbon nanotube in a metal by binding the magnetic material to the metal, in which the binding intervenor includes a radical initiator or a compound represented by the following Chemical Formula 1: [Chemical Formula 1] A-B, in which A is an organic functional group which is bound to the carbon nanotube, and B is an organic functional group which is bound to the magnetic material.

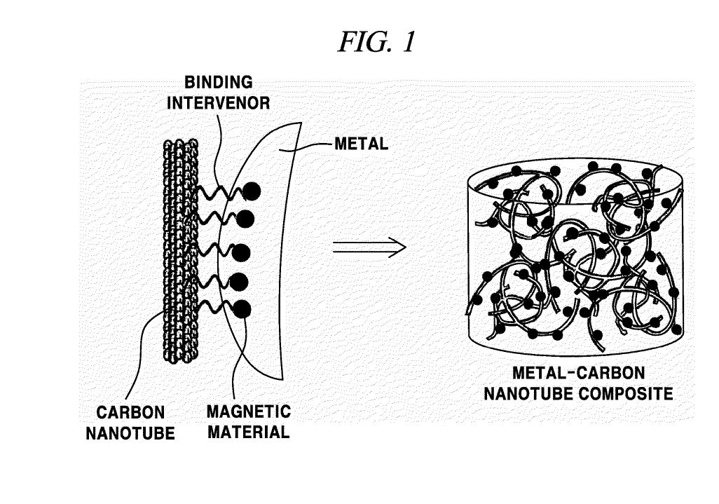

FIG. 1 is a schematic diagram provided to illustrate a preparing method of a metal-carbon nanotube composite in accordance with an example embodiment of the present disclosure. Referring to FIG. 1, the metal-carbon nanotube composite of the present disclosure may be prepared by chemically binding a magnetic material to a surface of a carbon nanotube using a binding intervenor and then mixing the carbon nanotube with a metal or a molten metal using a binding force of the magnetic material with respect to the metal.

By way of example, the magnetic material may include a transition metal oxide, but may not be limited thereto.

The preparing method of a metal-carbon nanotube composite may include, for example, chemically binding a magnetic material having a diameter greater than several nm to a surface of a carbon nanotube; mixing the carbon nanotube with a metal melt; and homogeneously dispersing the carbon nanotube in the metal melt using a strong binding property between an oxygen element and a metal contained in the magnetic material, but may not be limited thereto.

By way of example, the preparing method of a metal-carbon nanotube composite may be carried out under an inert gas atmosphere to suppress oxidation of the carbon nanotube, but may not be limited thereto. By way of example, the inert gas may include a gas selected from the group consisting of nitrogen, argon, neon, helium, and combinations thereof, but may not be limited thereto.

If the magnetic material is a material containing an oxygen element, the metal may include all metals which can be theoretically oxidized, but may not be limited thereto. By way of example, in the case of a metal which is not oxidized, it is possible to prepare a metal-carbon nanotube composite by mixing and physically stirring the metal with a carbon nanotube bound to a magnetic material.

By way of example, the binding intervenor may be carbonized and/or decomposed at a high temperature during a preparing process of the metal-carbon nanotube composite, but may not be limited thereto.

In accordance with an example embodiment of the present disclosure, the metal may include a metal or alloy containing one (or more) selected from the group consisting of Ni, Co, Fe, Pt, Au, Al, Cr, Cu, Mg, Mn, Mo, Rh, Si, Ta, Ti, W, U, V, Zr, Ge, and combinations thereof, but may not be limited thereto.

In accordance with an example embodiment of the present disclosure, the metal may be in a molten state, but may not be limited thereto.

In accordance with an example embodiment of the present disclosure, the radical initiator may include one (or more) selected from the group consisting of a peroxide-based polymerization initiator, an azo-based polymerization initiator, a redox-based polymerization initiator, and combinations thereof, but may not be limited thereto.

In accordance with an example embodiment of the present disclosure, the peroxide-based polymerization initiator may include a compound selected from the group consisting of ammonium persulfate, potassium persulfate, sodium persulfate, 1,1-bis(tert-arylperoxy)cyclohexane, 1,1-di(t-amylperoxy)cyclohexane, 1,1-bis(t-amyl peroxy)cyclohexane, 1,1-bis(t-butylperoxy)-3,3,5-trimethylcyclohexane, 1,1-bis(t-butyl peroxy)cyclohexane, 2,2-bis(t-butylperoxy)butane, 2,4-pentanedione oxide, 2,5-bis(t-butylperoxide)-2,5-dimethylhexane, 2,5-di(t-butylperoxide)-2,5-dimethyl-3-hexyne, 2-butanone peroxide, benzoyl peroxide, cumene hydroperoxide, di-t-amyl peroxide, dicumyl peroxide, lauroyl peroxide, luperox, t-butyl hydroperoxide, t-butyl peracetate, t-butyl peroxybenzoate, t-butyl peroxide, t-butylperoxy-2-ethylhexyl carbonate, and combinations thereof, but may not be limited thereto.

In accordance with an example embodiment of the present disclosure, the azo-based polymerization initiator may include a compound selected from the group consisting of 1,1′-azobis(cyclohexane-1-carbonitrile), 2,2′-azobis(amidinopropane)dihydrochloride, 2,2′-azobis(2-methylbutyronitrile), 2,2′-azobisisobutyronitrile, 2,2′-azobis(2,4-dimethylvaleronitrile), 2,2′-azobis(4-methoxy-2,4-dimethylvaleronitrile), 4,4′-azobis(4-cyanovaleric acid), dimethyl-2,2′-azobisisobutyrate, 2,2′-azobis[2-(2-imidazolin-2-yl)propane]dihydrochloride, 2,2′-azobis[2-(2-imidazolin-2-yl)propane], 2,2′-azobis[2-(hydroxymethyl)propionitrile], and combinations thereof, but may not be limited thereto.

In accordance with an example embodiment of the present disclosure, the organic functional group which is combined with the carbon nanotube may include an aromatic organic functional group, but may not be limited thereto.

In accordance with an example embodiment of the present disclosure, the organic functional group which is combined with the magnetic material may include one (or more) selected from the group consisting of a carboxyl group, an aldehyde group, a hydroxy group, an epoxy group, and combinations thereof, but may not be limited thereto.

In accordance with an example embodiment of the present disclosure, the compound of the above Chemical Formula 1 may include an aromatic carboxylic acid, but may not be limited thereto.

In accordance with an example embodiment of the present disclosure, the aromatic carboxylic acid may include benzoic acid, phthalic acid, or salicylic acid, but may not be limited thereto. By way of example, the benzoic acid may be benzoic anhydride, the phthalic acid may be terephthalic acid or phthalic anhydride, the phthalic anhydride may be di-butyl-phthalate or di-octyl-phthalate, and the salicylic acid may be acetylsalicylic acid or methyl salicylate, but may not be limited thereto.

In accordance with an example embodiment of the present disclosure, the magnetic material may include a transition metal oxide, but may not be limited thereto.

In accordance with an example embodiment of the present disclosure, the transition metal oxide may include one (or more) selected from the group consisting of iron oxide, cobalt oxide, nickel oxide, chromium oxide, magnetite, and combinations thereof, but may not be limited thereto.

In accordance with an example embodiment of the present disclosure, the size of the magnetic material may be from about 1 nm to about 50 nm, but may not be limited thereto. By way of example, the size of the magnetic material may be from about 1 nm to about 50 nm, from about 3 nm to about 50 nm, from about 5 nm to about 50 nm, from about 10 nm to about 50 nm, from about 20 nm to about 50 nm, from about 30 nm to about 50 nm, from about 40 nm to about 50 nm, from about 1 nm to about 40 nm, from about 1 nm to about 30 nm, from about 1 nm to about 20 nm, from about 1 nm to about 10 nm, from about 1 nm to about 7 nm, from about 1 nm to about 5 nm, from about 1 nm to about 3 nm, or from about 3 nm to about 10 nm, but may not be limited thereto.

In accordance with an example embodiment of the present disclosure, the step of binding the carbon nanotube to the magnetic material through the binding intervenor may include binding the magnetic material of from about 0.1 to about 20 parts by weight with respect to the carbon nanotube of about 1 part by weight, but may not be limited thereto. By way of example, the step of binding the carbon nanotube to the magnetic material through the binding intervenor may include binding the magnetic material of from about 0.1 to about 20 parts by weight, from about 0.5 to about 20 parts by weight, from about 1 to about 20 parts by weight, from about 2 to about 20 parts by weight, from about 5 to about 20 parts by weight, from about 10 to about 20 parts by weight, from about 0.1 to about 10 parts by weight, from about 0.1 to about 5 parts by weight, from about 0.1 to about 2 parts by weight, from about 0.1 to about 1 part by weight, from about 0.1 to about 0.5 parts by weight, or from about 2 to about 5 parts by weight with respect to the carbon nanotube of about 1 part by weight, but may not be limited thereto.

In accordance with an example embodiment of the present disclosure, the step of dispersing the carbon nanotube in the metal may include dispersing the carbon nanotube of 1 part by weight in the metal of from about 1 to about 500,000 parts by weight, but may not be limited thereto. By way of example, the step of dispersing the carbon nanotube in the metal may include dispersing the carbon nanotube of 1 part by weight in the metal of from about 1 to about 500,000 parts by weight, from about 1 to about 100,000 parts by weight, from about 1 to about 50,000 parts by weight, from about 1 to about 10,000 parts by weight, from about 1 to about 5,000 parts by weight, from about 1 to about 1,000 parts by weight, from about 1 to about 500 parts by weight, from about 1 to about 100 parts by weight, from about 1 to about 50 parts by weight, from about 1 to about 10 parts by weight, from about 1 to about 5 parts by weight, from about 1 to about 3 parts by weight, from about 3 to about 500,000 parts by weight, from about 5 to about 500,000 parts by weight, from about 10 to about 500,000 parts by weight, from about 20 to about 500,000 parts by weight, from about 50 to about 500,000 parts by weight, from about 100 to about 500,000 parts by weight, from about 500 to about 500,000 parts by weight, from about 1,000 to about 500,000 parts by weight, from about 5,000 to about 500,000 parts by weight, from about 10,000 to about 500,000 parts by weight, from about 50,000 to about 500,000 parts by weight, from about 100,000 to about 500,000 parts by weight, or, from about 10 to about 50 parts by weight, but may not be limited thereto.

In accordance with an example embodiment of the present disclosure, the step of binding the carbon nanotube to the magnetic material through the binding intervenor may include preparing a mixture including the carbon nanotube, the magnetic material, and the binding intervenor, and stirring the mixture to bind the carbon nanotube and the magnetic material, but may not be limited thereto.

In another general aspect of the present disclosure, there is provided a metal-carbon nanotube composite including a carbon nanotube, a magnetic material, and a metal, wherein the composite is prepared according to the one aspect of the present disclosure, and wherein the carbon nanotube and the magnetic material are homogeneously dispersed in the metal.

In the metal-carbon nanotube composite of the present disclosure, in order to homogeneously disperse the carbon nanotube and the metal which are different from each other in specific gravity and are not mixed well with each other, the carbon nanotube is bound to the magnetic material through a binding intervenor, so that the carbon nanotube has a specific gravity similar to that of the metal, and the carbon nanotube is bound to the metal using a binding force between the magnetic material bound to the carbon nanotube and the metal, so that the carbon nanotube is dispersed in the metal, but it may not be limited thereto. By way of example, the binding intervenor which may be used for binding the carbon nanotube to the magnetic material during a preparing process of the metal-carbon nanotube composite is carbonized and/or decomposed at a high temperature which may be accomplished during the preparing process of the metal-carbon nanotube composite and thus may not be substantially contained in the finally prepared metal-carbon nanotube composite.

By way of example, the metal-carbon nanotube composite of the present disclosure may be prepared by chemically binding a magnetic material, for example, a magnetic particle, to a surface of a carbon nanotube and then mixing the carbon nanotube with a metal or a molten metal, but may not be limited thereto. By way of example, the metal in which the carbon nanotube is dispersed may be light and strong. By way of example, if the metal is aluminum, the metal-carbon nanotube composite including the carbon nanotube of about 3% (v/v) dispersed in aluminum may have enhanced intensity about 3 times higher than pure aluminum and about 1.5 times higher than other aluminum alloys.

If the magnetic material contains an oxygen element, the metal may include all metals which can be theoretically oxidized, but may not be limited thereto.

By way of example, the magnetic material may include a magnetic particle, but may not be limited thereto.

The carbon nanotube chemically bound to the magnetic particle may have a specific gravity similar to that of the metal, but may not be limited thereto. By way of example, the carbon nanotube chemically bound to the magnetic particle has a specific gravity similar to that of the metal, and, thus, a phase separation does not occur. Therefore, the carbon nanotube can be homogeneously dispersed in the metal or in a molten metal, but may not be limited thereto.

By way of example, the radical initiator may include a functional group selected from the group consisting of a carboxyl group, an aldehyde group, a hydroxy group, an epoxy group, and combinations thereof, but may not be limited thereto.

A transition metal oxide can be chemically bound to a surface of the carbon nanotube using the radical initiator, and a radical electron contained in the radical initiator can be covalently bound to an electron in the P orbital on the surface of the carbon nanotube. A carboxyl group, as an organic functional group which can be bound to the magnetic material and is contained in the radical initiator, forms electrical coupling with a transition metal oxide such as magnetite. The transition metal oxide may contain oxygen bound to a metal such as iron, nickel, cobalt, and the like. The oxygen contained in the transition metal oxide forms a strong bond with oxidative metals including aluminum and thus can form a metal-carbon nanotube composite, but may not be limited thereto. As for the carbon nanotube contained in the metal-carbon nanotube composite prepared as described above, there is no change in basic property, and, thus, such a carbon nanotube can be used to prepare a high-strength metal or metal alloy.

Among the compounds in the above Chemical Formula 1, the organic functional group A, which can be bound to the carbon nanotube, may be bound to, for example, an electron in the pi orbital of the carbon nanotube through π-π stacking, but may not be limited thereto. Among the compounds in the above Chemical Formula 1, the organic functional group B, which can be bound to the magnetic material, may be electrostatically bound to, for example, a magnetic particle, but may not be limited thereto.

In accordance with an example embodiment of the present disclosure, the metal may include a metal or alloy containing one (or more) selected from the group consisting of Ni, Co, Fe, Pt, Au, Al, Cr, Cu, Mg, Mn, Mo, Rh, Si, Ta, Ti, W, U, V, Zr, Ge, and combinations thereof, but may not be limited thereto.

In accordance with an example embodiment of the present disclosure, the metal-carbon nanotube composite may include the magnetic material of from about 0.1 to about 20 parts by weight with respect to the carbon nanotube of about 1 part by weight, but may not be limited thereto. By way of example, the metal-carbon nanotube composite may include the magnetic material of from about 0.1 to about 20 parts by weight, from about 0.5 to about 20 parts by weight, from about 1 to about 20 parts by weight, from about 2 to about 20 parts by weight, from about 5 to about 20 parts by weight, from about 10 to about 20 parts by weight, from about 0.1 to about 10 parts by weight, from about 0.1 to about 5 parts by weight, from about 0.1 to about 2 parts by weight, from about 0.1 to about 1 part by weight, from about 0.1 to about 0.5 parts by weight, or from about 2 to about 5 parts by weight with respect to the carbon nanotube of about 1 part by weight, but may not be limited thereto.

In accordance with an example embodiment of the present disclosure, the metal-carbon nanotube composite may include the metal of from about 1 part by weight to about 500,000 parts by weight with respect to the carbon nanotube of about 1 part by weight, but may not be limited thereto. By way of example, the metal-carbon nanotube composite may include the metal of from about 1 to about 500,000 parts by weight, from about 1 to about 100,000 parts by weight, from about 1 to about 50,000 parts by weight, from about 1 to about 10,000 parts by weight, from about 1 to about 5,000 parts by weight, from about 1 to about 1,000 parts by weight, from about 1 to about 500 parts by weight, from about 1 to about 100 parts by weight, from about 1 to about 50 parts by weight, from about 1 to about 10 parts by weight, from about 1 to about 5 parts by weight, from about 1 to about 3 parts by weight, from about 3 to about 500,000 parts by weight, from about 5 to about 500,000 parts by weight, from about 10 to about 500,000 parts by weight, from about 20 to about 500,000 parts by weight, from about 50 to about 500,000 parts by weight, from about 100 to about 500,000 parts by weight, from about 500 to about 500,000 parts by weight, from about 1,000 to about 500,000 parts by weight, from about 5,000 to about 500,000 parts by weight, from about 10,000 to about 500,000 parts by weight, from about 50,000 to about 500,000 parts by weight, from about 100,000 to about 500,000 parts by weight, or, from about 10 to about 50 parts by weight with respect to the carbon nanotube of about 1 part by weight, but may not be limited thereto.

Hereinafter, an Example of the present disclosure will be explained in more detail. However, the present disclosure may not be limited thereto.

### Example

In the present Example, a multi-walled carbon nanotube (MWCNT, Nanocyl) having a diameter of from about 10 nm to about 13 nm was used as a carbon nanotube. Magnetite used herein was directly prepared by using a first iron chloride aqueous solution, a second iron chloride aqueous solution, and ammonia water. The magnetite had an average diameter of about 5 nm. Aluminum powders (AAL-10SF and AAL-30SF, Chang Sung Corporation) used herein had a diameter of from about 4 μm to about 10 μm and a diameter of from about 15 μm to about 25 μm, respectively. An aluminum flux (ASSTY(AF-1), JC Corporation) was used as an aluminum fluxing agent and had an average particle size of from about 6 μm to about 12 μm. As a radical initiator, 4,4-azobis(4-cyanovaleric acid) (v-501, Aldrich) was used.

In a melting experiment of the present Example, 20 g of the aluminum powders, 2 g of the aluminum flux, and 3 g of the carbon nanotube bound to a magnetic particle were used as materials, and the radical initiator was used in a weight ratio 2 times higher than the carbon nanotube.

Firstly, the magnetite as a magnetic particle was bound to a surface of the carbon nanotube using the radical initiator. After 2 g of the radical initiator was added to 1 L of distilled water and dissolved therein, 1 g of the carbon nanotube was added thereto with slow stirring for 10 hours at a temperature of 80° C. Then, 3 g of the magnetite was added thereto with stirring for about 30 minutes, so that the magnetite was bound to the surface of the carbon nanotube.

Thereafter, 3 g of the carbon nanotube bound to the magnetite was mixed well with 20 g of the aluminum powders, and the mixture was placed into a 20 ml ceramic crucible. The ceramic crucible was covered with 2 g of the aluminum flux and then placed into a heating furnace. While a nitrogen gas was supplied through an air line at an upper part of a reactor in order to suppress oxygen from being mixed in the heating furnace, the temperature was increased to a range of from about 620° C. to about 650° C., and the heating furnace was heated for about 30 minutes. In this process, the radical initiator used to bind the magnetite to the carbon nanotube was carbonized and decomposed into carbon molecules or the like. Then, heating of the heating furnace was stopped, and the temperature of the heating furnace was decreased to room temperature while nitrogen was continuously supplied. Thereafter, the ceramic crucible was broken, and an aluminum alloy aggregate was obtained. The obtained aluminum alloy was cut with a metal cutting saw, and a cross section thereof was observed with a scanning electron microscope (SEM) in order to check whether or not the carbon nanotube was well-dispersed.

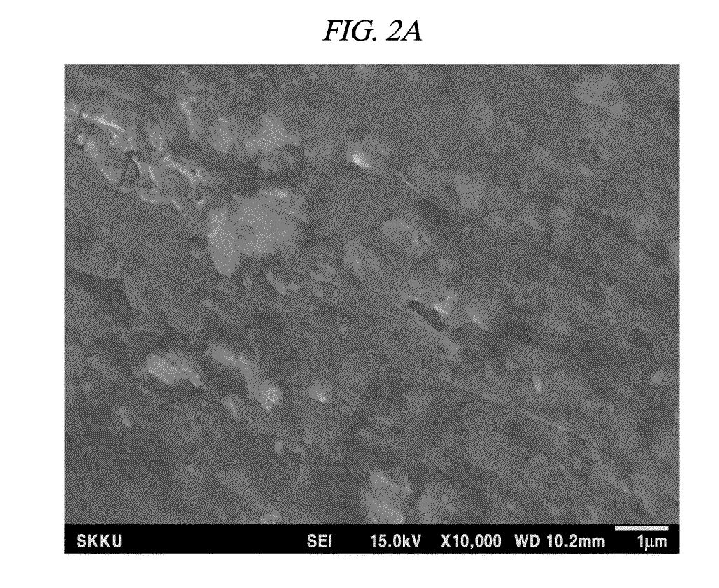

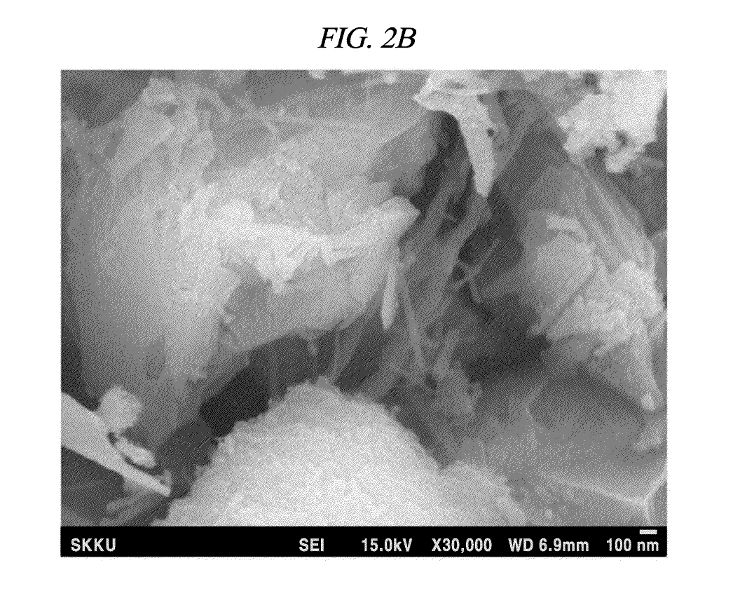

A result of the scanning electron microscopic analysis is shown in FIG. 2A and FIG. 2B. FIG. 2A is an image of a composite prepared from aluminum and a carbon nanotube which is not bound to magnetite, and FIG. 2B is an image of a composite prepared from aluminum and a carbon nanotube bound to magnetite. As a result, as shown in FIG. 2A, inside the aluminum aggregate in which the carbon nanotube not bound to magnetite was dispersed, no carbon nanotube was observed. This was because during melting at a high temperature, the carbon nanotube floated on an upper part of an aluminum melt and was not dispersed in the aluminum. Meanwhile, as shown in FIG. 2B, inside the aluminum aggregate in which the carbon nanotube bound to magnetite was dispersed, the carbon nanotube was observed as being mixed in molten aluminum.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

We claim:

1. A preparing method of a metal-carbon nanotube composite, comprising:
a step of binding a carbon nanotube to a magnetic material through a binding intervenor; and
a step of dispersing the carbon nanotube in a metal by binding the magnetic material to the metal,
wherein the binding intervenor includes a radical initiator or a compound represented by the following Chemical Formula 1: 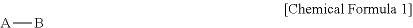
wherein A is an organic functional group which is bound to the carbon nanotube, and B is an organic functional group which is bound to the magnetic material.

2. The preparing method of claim 1,
wherein the metal includes a metal selected from the group consisting of Ni, Co, Fe, Pt, Au, Al, Cr, Cu, Mg, Mn, Mo, Rh, Si, Ta, Ti, W, U, V, Zr, and Ge, or an alloy thereof.

3. The preparing method of claim 1,
wherein the metal is in a molten state.

4. The preparing method of claim 1,
wherein the radical initiator includes a peroxide-based polymerization initiator, an azo-based polymerization initiator, a redox-based polymerization initiator, or combinations thereof.

5. The preparing method of claim 4,
wherein the peroxide-based polymerization initiator includes ammonium persulfate, potassium persulfate, sodium persulfate, 1,1-bis(tert-arylperoxy)cyclohexane, 1,1-di(t-amylperoxy)cyclohexane, 1,1-bis(t-amyl peroxy)cyclohexane, 1,1-bis(t-butylperoxy)-3,3,5-trimethylcyclohexane, 1,1-bis(t-butyl peroxy)cyclohexane, 2,2-bis(t-butylperoxy)butane, 2,4-pentanedione oxide, 2,5-bis(t-butylperoxide)-2,5-dimethylhexane, 2,5-di(t-butylperoxide)-2,5-dimethyl-3-hexyne, 2-butanone peroxide, benzoyl peroxide, cumene hydroperoxide, di-t-amyl peroxide, dicumyl peroxide, lauroyl peroxide, luperox, t-butyl hydroperoxide, t-butyl peracetate, t-butyl peroxybenzoate, t-butyl peroxide, t-butylperoxy-2-ethylhexyl carbonate, or combinations thereof.

6. The preparing method of claim 4,
wherein the azo-based polymerization initiator includes 1,1′-azobis(cyclohexane-1-carbonitrile), 2,2′-azobis(amidinopropane)dihydrochloride, 2,2′-azobis(2-methylbutyronitrile), 2,2′-azobisisobutyronitrile, 2,2′-azobis(2,4-dimethylvaleronitrile), 2,2′-azobis(4-methoxy-2,4-dimethylvaleronitrile), 4,4′-azobis(4-cyanovaleric acid), dimethyl-2,2′-azobisisobutyrate, 2,2′-azobis[2-(2-imidazolin-2-yl)propane]dihydrochloride, 2,2′-azobis[2-(2-imidazolin-2-yl)propane], 2,2′-azobis[2-(hydroxymethyl)propionitrile], or combinations thereof.

7. The preparing method of claim 1,
wherein the organic functional group which is combined with the carbon nanotube includes an aromatic organic functional group.

8. The preparing method of claim 1,
wherein the organic functional group which is combined with the magnetic material includes a carboxyl group, an aldehyde group, a hydroxy group, an epoxy group, or combinations thereof.

9. The preparing method of claim 1,
wherein the compound of the chemical formula 1 includes an aromatic carboxylic acid.

10. The preparing method of claim 9,
wherein the aromatic carboxylic acid includes benzoic acid, phthalic acid, or salicylic acid.

11. The preparing method of claim 1,
wherein the magnetic material includes a transition metal oxide.

12. The preparing method of claim 11,
wherein the transition metal oxide includes iron oxide, cobalt oxide, nickel oxide, chromium oxide, magnetite, or combinations thereof.

13. The preparing method of claim 1,
wherein the size of the magnetic material is from 1 nm to 50 nm.

14. The preparing method of claim 1,
wherein the step of binding the carbon nanotube to the magnetic material through the binding intervenor includes binding the magnetic material in a ratio of from 0.1 to 20 parts by weight of the magnetic material to 1 part by weight of the carbon nanotube.

15. The preparing method of claim 1,
wherein the step of dispersing the carbon nanotube in the metal includes dispersing the carbon nanotube in a ratio of 1 part by weight of the carbon nanotube to from 1 to 500,000 parts by weight of the metal.

16. The preparing method of claim 1,
wherein the step of binding the carbon nanotube to the magnetic material through the binding intervenor includes
preparing a mixture including the carbon nanotube, the magnetic material, and the binding intervenor, and
stirring the mixture to bind the carbon nanotube and the magnetic material.

17. A metal-carbon nanotube composite, comprising:
a carbon nanotube; a magnetic material; and a metal,
wherein the composite is prepared according to the preparing method of claim 1, and
wherein the carbon nanotube and the magnetic material are homogeneously dispersed in the metal.

18. The metal-carbon nanotube composite of claim 17,
wherein the metal-carbon nanotube composite includes the magnetic material in a ratio of from 0.1 to 20 parts by weight of the magnetic material to 1 part by weight of the carbon nanotube.

19. The metal-carbon nanotube composite of claim 17,
wherein the metal-carbon nanotube composite includes the metal in a ratio of from 1 part by weight to 500,000 parts by weight of the metal to 1 part by weight of the carbon nanotube.
